(19) United States
(12) Patent Application Publication
(10) Pub. No.: US 2017/0243296 A1
(43) Pub. Date: Aug. 24, 2017

(54) Real Estate Investment System and Method of Controlling a Commercial System by Generating Key Investment Indicators

(71) Applicant: REVESTOR LLC, San Francisco, CA (US)

(72) Inventor: William A. Lyons, La Jolla, CA (US)

(73) Assignee: REVESTOR LLC, San Francisco, CA (US)

(21) Appl. No.: 15/592,086

(22) Filed: May 10, 2017

Related U.S. Application Data
(63) Continuation of application No. 13/207,664, filed on Aug. 11, 2011, now abandoned.

(51) Int. Cl. G06Q 40/06; G06Q 50/16

(52) U.S. Cl. CPC G06Q 40/06; G06Q 50/16

(57) ABSTRACT

A commerce system is controlled by collecting information related to property assets from members of the commerce system, storing the information in a database, determining a plurality of sale transaction values for the property asset based upon the information stored in the database, determining a plurality of key investment indicators from the sale transaction values, determining an investment rating based on the key investment indicators, and utilizing the key investment indicators and investment rating to control a decision to conduct a sale transaction for the property asset within the commerce system. The sale transaction values include offer price, fair market rent, taxes, Mello-Roos, insurance, homeowner association fees, property management fees, total expenses, downpayment, loan type, interest rate, and mortgage payment. The key investment indicators include net operating income, capitalization rate, debt service ratio, cash flow, cash-on-cash return, and return on investment.

### CLAIM TO DOMESTIC PRIORITY

The present application is a continuation of U.S. patent application Ser. No. 13/207,664, filed Aug. 11, 2011, which application is incorporated herein by reference.

### FIELD OF THE INVENTION

The present invention relates in general to asset management and, more particularly, to a real estate investment system and method of controlling a commercial system by generating key investment indicators for an investor.

### BACKGROUND OF THE INVENTION

A common practice in the present economic system involves people, groups, and business entities making investments in a variety of assets. An investor may choose to purchase, acquire, or otherwise control a particular asset with the expectation of making a profitable return on that investment. The return on investment generates revenue or builds equity, which permits further investment, creates wealth, provides employment, increases the tax base, and stimulates economic growth. The principle of investment with a positive rate of return is a fundamental building block of an economic system.

Assets that may be of interest to an investor can take a variety of forms. For example, the investor may be interested in securities trading. A myriad of tools exist to assist the investor in evaluating the present value and potential future value of the security. Based on an analysis of the security, the investor may make a decision to purchase the security at a particular point in time with the expectation of earning a return on that transaction. In another example, the investor may decide to purchase an interest in a revenue-generating business or going concern. Again, many tools exist to assist the investor in evaluating the present value and potential future value of the business. Based on an analysis of the business, the investor may make a decision to purchase an interest in the business with the expectation of earning a return on that transaction. The same principles apply to other assets, such as commodities, collectible items, commercial equipment, and personal education, just to name a few.

Economic and financial models are common tools used to evaluate potential investments. Economic and financial modeling and planning involves estimation or prediction of the performance and outcome of real systems, given specific sets of input data of interest. An economic-based system will have many variables and influences which determine its behavior. A model is a mathematical expression or representation, which predicts the outcome or behavior of the system under a variety of conditions. In one sense, it is relatively easy to review historical data, understand its past performance, and state with relative certainty that past behavior of the system was indeed driven by the historical data. A more difficult task is to generate a mathematical model of the system, which predicts how the system will behave with different sets of data and assumptions.

In its basic form, the economic model can be viewed as a predicted or anticipated outcome of a system defined by a mathematical expression and driven by a given set of input data and assumptions. The mathematical expression is formulated or derived from principles of probability and statistics, often by analyzing historical data and corresponding known outcomes, to achieve a best fit of the expected behavior of the system to other sets of data. In other words, the model should be able to predict the outcome or response of the system to a specific set of data being considered or proposed, within a level of confidence, or an acceptable level of uncertainty.

While comprehensive economic modeling is available for many types of investing, such as securities trading and business evaluation for the benefit of investors, real estate investing has not received the same level of attention. Real estate investing typically involves a simplified approach with consideration of market value, capital outlay, interest rates, potential cash flow, and tax advantages in evaluating comparable returns. For example, on the cost side of the equation, the real estate investor will consider purchase price, interest rate, closing costs, maintenance, repairs, improvements, and other expenses. On the income side, the investor will evaluate the rental market, rental income, leverage, depreciation and other tax benefits, and equity. The difference between the cost and income determines the potential cash flow and other forms of return on the investment. The real estate investor will look for low purchase prices, low interest rates, and favorable rental rates to maximize the cash flow.

In the case of residential or commercial real estate, an investor typically uses a real estate agent to gather information and evaluate specific properties. FIG. 1 illustrates a conventional real estate system 10 involving investor 12 working with real estate agent 14 to review potential properties. Real estate agent 14 identifies properties 16 and 18 for consideration by investor 12. Investor 12 may find property 20 on his or her own using real estate website 22. Properties 16-20 each represent a single family home, multi-family building, commercial property, farm, or unimproved land. Investor 12 is interested in purchasing one or more properties 16-20 as an investment with the expectation of a return on the investment, typically in the form of a positive cash flow or foreseeable increase in equity.

Investor 12 may accompany real estate agent 14 in reviewing property 16 and 18 on-line and in person, and then run the numbers to understand the prospects of a positive return on investment. Investor 12 and real estate agent 14 will discuss purchase price, downpayment, improvements, credit rating, interest rate, closing costs, maintenance, expenses, improvements, rental market, rental income, desirability of the property for renters, tax benefits, cash flow, and equity for each property 16-18. Investor 12 and real estate agent 14 will compare and contrast the relevant numbers for each property 16-18 and select one or more properties to pursue in negotiations with the seller. Most investors 12 rely heavily on the data received from agent 14, as well as the agent's professional experience and advice.

If investor 12 is experienced with real estate transactions, he or she may evaluate property 20 without the assistance of agent 14. A large number of on-line databases and websites 22 are available for investor 12 to review residential and commercial property. The websites show property location, description, photos, and listing price, usually for one property at a time. The website may include links to lending institutions and financing calculators but generally lack reliable, comprehensive, and objective investment analysis and advice. A significant portion of the homework is left to investor 12. In any case, reviewing and evaluating residential or commercial properties on an individual basis is time consuming and filled with uncertainty and sometimes assumptions that fall short of reality.

Depending on the experience of investor 12 and real estate agent 14, the assumptions or key investment indicators that form the basis for a decision to invest in a particular property may not achieve the expectations. The anticipated purchase price, usually less than the listing price, can still be underestimated. That is, the seller may not accept the initial offer from investor 12. Investor 12 must decide whether to increase the offer price to continue the negotiation. The investment numbers must be recalculated with each step of the negotiation with the seller. The interest rate offered by the lending institution can vary with the purchase price, downpayment, credit rating, appraisal, credit market, and other dynamic factors. The repairs, maintenance, and expenses can be underestimated, even with a thorough home inspection.

While purchase price, downpayment, and interest rate can often be determined with a reasonable degree of certainty, an equally important but less measurable consideration in the investment decision relies upon accurate estimation of the rental prospects, including rental market, rental income, selection of responsible tenants, management of the property, and exit strategy. The true rental attributes often cannot be fully understood until after the transaction is complete. Investor 12 may have difficulty in finding tenants willing to pay the amount needed by the investor to realize a positive cash flow. The rental market can change with a downturn in the local economy resulting in lower market rental values. The property may be less desirable as a rental than anticipated by investor 12 or real estate agent 14. Hidden defects in the property may surface after closing leading to higher than expected capital improvements and repairs. Renters may demand additional improvements, e.g., new carpeting, painting, landscaping, or appliances, to accept the lease. In commercial property, the tenant may want structural changes, such as a revised office layout.

A successful investor needs access to up-to-date, comprehensive, and reliable analysis tools to understand a realistic potential for a positive return on investment for the asset being considered for purchase. While no investment brings a guarantee of profitable return, the investment tools can reduce risk of inaccurate assumptions and increase the likelihood of making a sound investment decision.

### BRIEF DESCRIPTION OF THE DRAWINGS

FIG. 1 is a schematic diagram illustrating a conventional real estate system;

FIG. 2 illustrates a real estate system with an investment service provider;

FIG. 3 illustrates a plurality of members of a real estate based commerce system;

FIG. 4 illustrates an electronic communication network between the investor, investment service provider, and members of the real estate based commerce system;

FIG. 5 illustrates a computer system operating with the electronic communication network;

FIG. 6 illustrates an investor profile and registration webpage with the investment service provider;

FIG. 7 illustrates an investor login webpage for the investment service provider;

FIG. 8 illustrates a webpage for selecting search criteria for investment properties;

FIG. 9 illustrates a webpage for searching by key investment indicators;

FIG. 10 illustrates a webpage for displaying a property description, sale transaction values, and key investment indicators for a selected property;

FIG. 11 illustrates sale transaction values and key investment indicators for the selected property;

FIGS. 12a-12b illustrate sale transaction values and key investment indicators related to exit strategies for the selected property;

FIG. 13 illustrates an investment rating determined from the key investment indicators for the selected property;

FIG. 14 illustrates a list of service providers with reputation ratings for selection by the investor; and

FIG. 15 illustrates the process of controlling a decision to conduct a sale transaction for a property asset within a commerce system based on key investment indicators and investment rating.

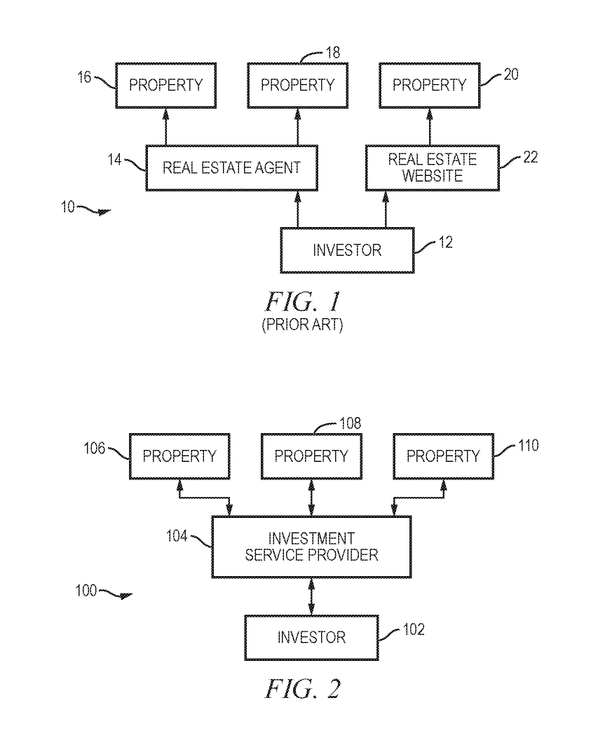

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

A common practice in the present economic system involves people, groups, and business entities making investments in a variety of assets. An investor may choose to purchase, acquire, or otherwise control a particular asset with the expectation of making a profitable return on that investment. The return on investment generates revenue or builds equity which permits further investment, creates wealth, provides employment, increases the tax base, and stimulates economic growth. The principle of investment with a positive rate of return is a fundamental building block of an economic system.

Assets that may be of interest to an investor take a variety of forms. For example, the investor may be interested in real estate. Based on an analysis of a real property, the investor may make a decision to purchase the property with the expectation of earning a return on that transaction.

FIG. 2 illustrates a real estate system 100 involving investor 102 working with and through investment service provider (ISP) 104 to review potential investment properties 106, 108, and 110. Investor 102 can be a person, group of persons, or business entity. A person looking for a property as a personal residence, i.e., prospective homeowner, can also utilize ISP 104. Properties 106-110 each represent a single family home, multi-family building, commercial property, farm, unimproved land, or other real property. Investor 102 is interested in purchasing one or more properties 106-110 as an investment with the expectation of a return on the investment, typically in the form of a positive cash flow or foreseeable increase in equity.

ISP 104 offers investor 102 a set of tools to perform investment due diligence on properties 106-110. ISP 104 gives investor 102 the ability to search multiple investment properties 106-110 by property attributes or one or more key investment indicators, such as capitalization rate, debt service ratio, net operating income, cash flow, cash-on-cash return, or return on investment, and provide reliable and comprehensive investment analysis and risk assessment of each investment property. ISP 104 rank orders each investment property 106-110 based upon a selected sort field. ISP 104 saves investor 102 considerable time and money by providing access to a comprehensive, reliable, and objective investment model or comparative investment service. The key investment indicators and rankings of properties 106-110 can be stored and utilized by investor 102 to identify one or more properties that represent a sound investment based on their particular investment strategy.

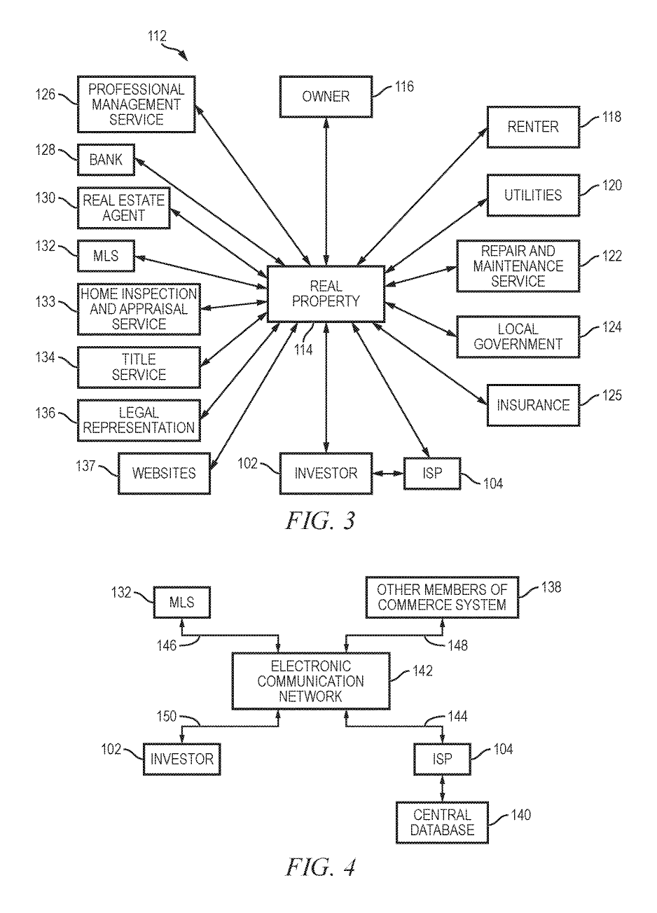

FIG. 3 illustrates a commerce system 112 including real property 114 presently held by owner 116. Owner 116 can be a person, group of persons, or business entity. Property 114 has value and revenue generating potential. For example, property 114 may be leased by renter 118. Property 114 consumes resources in terms of waste disposal, water, gas, and electricity as represented by utilities 120. Property 114 requires services from repair and maintenance service 122. Local government 124 collects tax revenues from property 114. Insurance 125 provides insurance coverage for property 114. Property 114 requires management by owner 116 or professional management service 126. Property 114 can be held as loan collateral by bank or other lending institution 128. Real estate agent 130 becomes involved with change of ownership of property 114, as well as interactions with professional management service 126 and renter 118. Multiple listing service (MLS) or other property data service 132 provides a list of properties with attributes available for purchase or leasing. Home inspection and appraisal service 133 provides a report of the condition of property 114, as well as a fair market value. Title service 134 provides title searches and title insurance. Legal representation 136 provides legal services. Websites 137 provide real estate related information relevant to property 114. The members of commerce system 112 include owner 116, renter 118, utilities 120, repair and maintenance service 122, local government 124, insurance 125, professional management service 126, bank or other lending institution 128, real estate agent 130, MLS 132, home inspection and appraisal service 133, title services 134, legal representation 136, and websites 137. Investor 102 and ISP 104 also operate as members of commerce system 112.

The normal operating state of commerce system 112 is relatively routine. Owner 116 makes monthly mortgage payments to bank 128. Renter 118 makes monthly rent payments to owner 116. Owner 116 or professional management service 126 engages repair and maintenance service 122 to perform necessary upkeep and repairs of property 114. Local government 124 collects property taxes. Certain abnormalities within commerce system 112 can occur if owner 116 falls behind on the loan payments to bank 128 or neglects property taxes due to local government 124. Other issues arise if owner 116 fails to pay utilities 120 or if renter 118 cannot make the rent payment.

The sale of property 114 creates a special situation that affects most if not all members of commerce system 112 collectively and simultaneously. Once property 114 becomes the subject of a potential change of ownership, the activity within commerce system 112 directed toward the property dramatically increases. Based on the data received from ISP 104, investor 102 initiates a chain of events associated with a potential sale transaction that involves multiple members of commerce system 112. Renter 118 must be contacted at least to give notice and possibly negotiate concessions or early termination of the lease. Utilities 120 must change the responsible party or may be discontinued. Repair and maintenance 122 is involved in bringing property 114 up to standards agreeable to investor 102 and owner 116. Local government 124 must approve the sale, resolve any outstanding tax liability or liens, and update the tax status and responsible party. Insurance 125 can change insurance underwriter or coverage. The new owner may change professional management service 126 to another service provider or terminate the service all together. The present loan with bank or other lending institution 128 will likely be paid off in favor of new financing. Investor 102 engages real estate agent 130. MLS 132 posts property 114 as available for purchase or lease. Real estate agent 130 reviews MLS 132 and shows various properties, presents offers, negotiates the sale, and oversees the closing of property 114. Investor 102 uses ISP 104 and MLS 132 to analyze and evaluate various investment properties like 114. Bank 128 must agree to payoff of the loan, release collateral, and approve new financing. Home inspection and appraisal service 133 determines the condition of property 114 and its fair market value. Title service 134 conducts title searches, provides title insurance, and processes the closing. Legal representation 136 can be engaged at the appropriate time for legal services associated with the sale transaction of property 114.

All the members of commerce system 112 must review and approve, conduct appropriate activities, or at least be aware of the proposal to change ownership of property 114. The interaction between investor 102 and ISP 104 affects control over commerce system 112 by causing a change of ownership activities to occur with respect to property 114 within the commerce system. ISP 104 is a key resource and catalyst in the controlling decision by investor 102 to initiate a change of ownership of property 114 and associated commercial activities within commerce system 112. The control over the decision to change ownership of property 114 based on an investment analysis conducted by investor 102 and ISP 104 migrates change of status and other commercial activity by and between the members of commerce system 112.

FIG. 4 illustrates further detail of the interaction between investor 102, ISP 104, MLS 132, and other members of commerce system 138 associated with a decision to conduct a sale transaction and change ownership of property 114 that controls commercial activity within commerce system 112. ISP 104 is a third party service provider that assists investor 102 with the analysis and evaluation of properties within commerce system 112 and purchasing decision process by providing access to an investment model or comparative investment service. ISP 104 works with investor 102, MLS 132, and other members of commerce system 138 by optimizing the selection of properties by price, expenses, costs, key investment indicators, and other attributes. More specifically, ISP 104 operates and maintains central database 140 that prioritizes property attributes and optimizes property selection according to the investor's preferences. ISP 104 saves investor 102 considerable time and money by providing access to a comprehensive, reliable, and objective investment model or comparative investment service.

Economic and financial models are common tools used to evaluate potential investments. Economic and financial modeling and planning involves estimation or prediction of the performance and outcome of real systems, given specific sets of input data of interest. An economic-based system will have many variables and influences which determine its behavior. A model is a mathematical expression or representation which predicts the outcome or behavior of the system under a variety of conditions. In one sense, it is relatively easy to review historical data, understand its past performance, and state with relative certainty that past behavior of the system was indeed driven by the historical data. A more difficult task is to generate a mathematical model of the system, which predicts how the system will behave with different sets of data and assumptions.

In its basic form, the economic model can be viewed as a predicted or anticipated outcome of a system defined by a mathematical expression and driven by a given set of input data and assumptions. The mathematical expression is formulated or derived from principles of probability and statistics, often by analyzing historical data and corresponding known outcomes, to achieve a best fit of the expected behavior of the system to other sets of data. In other words, the model should be able to predict the outcome or response of the system to a specific set of data being considered or proposed, within a level of confidence, or an acceptable level of uncertainty.

For ISP 104 to provide efficient and effective investment related services to investor 102, central database 140 must be populated with up-to-date, comprehensive, reliable, and accurate data related to real estate investment opportunities within commerce system 112. ISP 104 collects investment related data from a variety of public and private data sources within commerce system 112 through an electronic communication network 142. Electronic communication network 142 contains bi-directional electronic communication channels or links between investor 102, ISP 104, MLS 132, and other members of commerce system 138. For example, ISP 104 is connected to electronic communication network 142 by way of electronic communication channel or link 144. Likewise, MLS 132 is connected to electronic communication network 142 by way of electronic communication channel or link 146. The other members of commerce system 138 are connected to electronic communication network 142 by way of electronic communication channel or link 148. Investor 102 is connected to electronic communication network 142 by way of electronic communication channel or link 150.

Electronic communication network 142 is a distributed network of interconnected routers, gateways, switches, and servers, each with a unique address to enable communication between individual computers, cellular telephones, electronic devices, or nodes within the network. In one embodiment, electronic communication network 142 is a global, open-architecture network, commonly known as the Internet. Alternatively, electronic communication network 142 is a wireless telephone network. Electronic communication channels or links 144-150 are bi-directional and transmit data between the users and electronic communication network 142 in a hard-wired or wireless configuration. For example, ISP 104 operates a computer system with standard operating system, document processing software, email, texting, and Internet capability. MLS 132 can operate a computer system with standard operating system, document processing software, email, texting, and Internet capability. The other members of commerce system 138 can operate a computer system with standard operating system, document processing software, email, texting, and Internet capability. Investor 102 may have a computer system or cellular phone with standard operating system, document processing software, email, texting, and Internet capability.

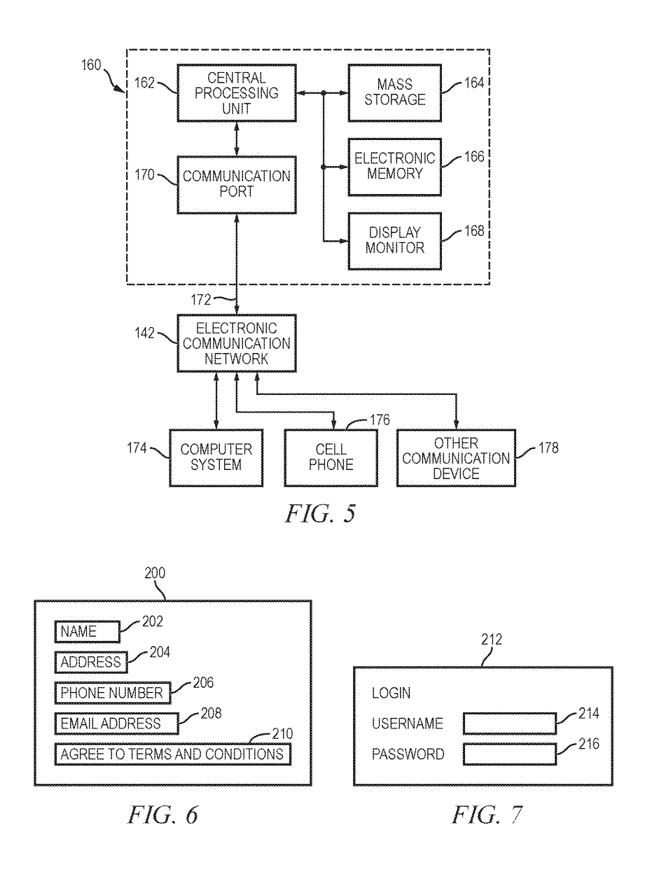

Further detail of the computer systems used in communication system 142 is shown in FIG. 5 as a simplified computer system 160 for executing the software program used in the electronic communication process. Computer system 160 is a general purpose computer including a central processing unit or microprocessor 162, mass storage device or hard disk 164, electronic memory 166, display monitor 168, and communication port 170. Communication port 170 represents a modem, high-speed Ethernet link, wireless, or other electronic connection to transmit and receive input/output (I/O) data over communication link 172 to electronic communication network 142. Computer system or server 174 can be configured in the same manner as shown for computer 160. Computer system 174 and cellular telephone 176 transmit and receive information and data over communication network 142. Other electronic devices 178 can also transmit and receive information and data over communication network 142.

Computer systems 160 and 174 can be physically located in any location with access to a modem or communication link to network 142. For example, computer 160 and 174 can be located in the user's home or business office. Alternatively, computer 160 and 174 can be mobile and follow the user to any convenient location, e.g., remote offices, customer locations, hotel rooms, residences, vehicles, public places, or other locales with electronic access to electronic communication network 142. ISP 104 may use computer system 160 or 174 in its business office. Investor 102 can access ISP 104 by mobile application operating in cell phone 176.

Each of the computers runs application software and computer programs, which can be used to display user interface screens, execute the functionality, and provide the electronic communication features as described below. The application software includes a local email application, Internet browser, word processor, spreadsheet, and the like. In one embodiment, the screens and functionality come from the application software, i.e., the electronic communication runs directly on computer system 160. Alternatively, the screens and functions are provided remotely from one or more websites on servers within electronic communication network 142.

The software is originally provided on computer readable media, such as compact disks (CDs), external drive, or other mass storage medium. Alternatively, the software is downloaded from electronic links, such as the host or vendor website. The software is installed onto the computer system hard drive 164 and/or electronic memory 166, and is accessed and controlled by the computer's operating system. Software updates are also electronically available on mass storage medium or downloadable from the host or vendor website. The software, as provided on the computer readable media or downloaded from electronic links, represents a computer program product containing computer readable program code embodied in a computer program medium.

ISP 104 uses electronic communication network 142 to collect real estate investment related data from the members of commerce system 112 and stores the data in central database 140. For example, ISP 104 communicates with MLS 132 to obtain relevant data for numerous investment properties like 114. The data collected from MLS 132 includes listing price, type of dwelling, square footage, layout, property description, photographs, utilities, school systems, tax basis, community features, legal description, lender information, seller remarks, foreclosure status, and other property information. The MLS data is stored in central database 140. ISP 104 also communicates with utilities 120 to determine water and electricity rates and historical consumption by the property. Utilities 120 can also provide information on service issues, easements, and water quality. ISP 104 communicates with repair and maintenance service 122 to collect information on repair and maintenance history, as well as pending or needed property improvements. ISP 104 communicates with local government 124 to collect information on tax status, liens, encumbrances, zoning, pending litigation, health issues for the community, and other matters of public record. ISP 104 communicates with insurance 125 to collect information on insurance coverage, claims, and pricing. ISP 104 communicates with professional management services 126 to collect information on rental history, homeowners association rules and regulations, and repair and maintenance records. ISP 104 communicates with bank 128 to collect information on loan status, delinquencies, interest rates, and foreclosure status. ISP 104 communicates with home inspection and appraisal service 133 to collect information on the condition of the property and fair market value. ISP 104 communicates with title services 134 to collect information on title history, liens, encumbrances, closing costs, and other public records. ISP 104 communicates with legal representation 136 to collect information on pending litigation and other legal issues. The property information collected by ISP 104 through electronic communication network 142 is stored in central database 140.

ISP 104 must actively and continuously gather up-to-date investment information in order to maintain reliable and comprehensive data on central database 140. While public information from MLS 132, utilities 120, local government 124, and title service 134 can usually be readily obtained, investor information from private sources can be more involved. Other real estate information can be obtained from public websites, such as Listhub, Point2, Real Estate Transaction Standard (RETS), Owners.com, ForSaleByOwner.com, FSBO.com, Lender Processing Services (LPS), Dataquick, Propertylnfo, Costar Group, Zillow, Eppraisal, Corelogic, Walkscore, SpotCrime, Onboard Infomatics, Maponics, Farmers, Craigslist, Padmapper, Rentometer, HotPads, Move.com, Oodle, Google, Microsoft Bird's Eye View, and other websites 137. Certain members of commerce system 112, such as repair and maintenance service 122, professional management service 126, and bank 128, act as custodians of private information may be prohibited by confidentiality obligations or otherwise reluctant to share information. The private information can be obtained by authorization from owner 116. As ISP 104 gains acceptance and investor 102 come to rely on the service to make purchase decisions, owner 116 will be motivated to provide authorization to disclose private information to ISP 104 in order to maximize opportunities to find a buyer and sell property 114.

ISP 104 provides investment analysis and evaluation services for the benefit of investor 102. Investor 102 can identify search parameters and other criteria relevant to his or her investment strategy. ISP 104 accesses central database 140 to generate a report or search results of properties that could be of interest to investor 102. ISP 104 can determine key investment indicators, such as capitalization rate, debt service ratio, net operating income, cash flow, cash-on-cash return, and return on investment, for consideration by investor 102.

To access the investment analysis tools provided by ISP 104, investor 102 first creates an account and profile with ISP 104. The account set-up involves a registration process wherein the user accesses website 200 operated by ISP 104 and provides data to complete the registration and activation process, as shown in FIG. 6. The investor can access registration website 200 by computer 174 or cellular telephone 176 by typing the uniform resource locator (URL) for website 200, or by clicking on a banner located on another website, which re-directs the user to predetermined landing pages for website 200. The registration webpage 200 includes name in block 202, address in block 204, phone number in block 206, email address in block 208, and other information and credentials necessary to establish a profile and identity for investor 102. Investor 102 agrees to the terms and conditions of conducting electronic communication through ISP 104 in block 210. ISP 104 may require a paid subscription from investor 102 to access and utilize its services.

Investor 102 can access ISP 104 through webpage 212 by entering username 214 and password 216, as shown in FIG. 7. The username can be the phone number or email address and the password assigned to or selected by investor 102. Investor 102 can change personal information, and otherwise update the profile. The profile of investor 102 remains secure and confidential within ISP 104.

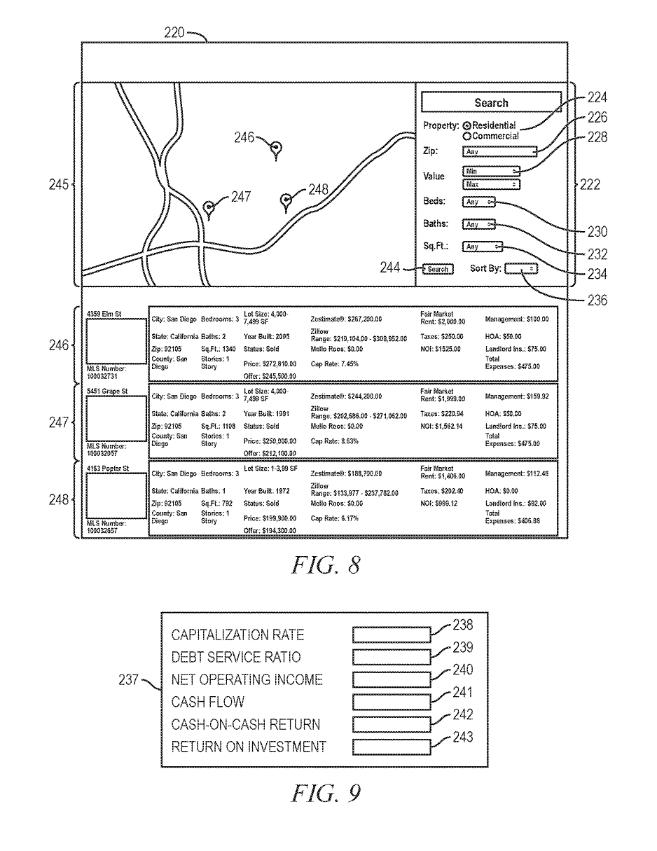

In an example of investor 102 using ISP 104 to identify and analyze one or more investment properties, the investor logs into ISP webpage 212. A search webpage 220 is presented to investor 102, as shown in FIG. 8. Search webpage 220 allows investor 102 to make selections and enter data by clicking buttons with a mouse, typing into data fields with the keyboard, or selecting predetermined values from drop-down menus. Alternatively, if investor 102 accesses ISP 104 through a mobile application on a mobile device such as a cellular phone, it is possible for investor 102 to select buttons by using a touch-sensitive display screen on the mobile phone.

In search block 222, investor 102 selects between residential or commercial in circles 224. Residential properties include single family homes, planed urban developments, condominiums, townhomes, multi-family units, and mobiles homes. Commercial properties include apartment complexes, hotels, offices, industrial buildings, land, and mobile home parks. Investor 102 also enters preferred zipcode, state, or other geographic region in block 226, price range in blocks 228, number of bedrooms in block 230, number of bathrooms in block 232, and square footage range in block 234. For example, investor 102 selects “residential” in circles 224 and enters “Arizona” in block 226, price range of “100000-300000” in blocks 228, “3-4” for number of bedrooms in block 230, blank for number of bathrooms in block 232 (no preference), square footage range of “1500-2500” in block 234. Investor 102 can select from a plurality of sort criteria in block 236. The sort criteria can be any field of the property description.

The search criteria can also be defined in webpage 237 by the key investment indicators or ranges of key investment indicators, as shown of FIG. 9. A target capitalization rate or range of capitalization rates can be specified in block 238. A target debt service ratio or range of debt service ratios can be specified by investor 102 in block 239. A target net operating income or range of net operating incomes can be specified in block 240. A target cash flow or range of cash flows can be specified by investor 102 in block 241. A target cash-on-cash return or range of cash-on-cash returns can be specified by investor 102 in block 242. A target return on investment or range of return on investments can be specified by investor 102 in block 243. The sort criteria in block 236 can be any of the key investment indicators.

Investor 102 clicks on search button 244. ISP 104 accesses central database 140 and compiles a list of properties matching the search criteria specified by investor 102. The properties can be for sale through real estate broker, for sale by owner, for sale by lending institution following foreclosure, or for sale by auction. The matching individual properties with investment analysis are presented in map block 245 and property blocks 246, 247, and 248 sorted in the order specified in the search criteria. Map block 245 presents a geographic illustration of the location of real properties 246-248. Each property block 246-248 has summary property information such as a photograph of property photo, city, state, zipcode, county, number of bedrooms, number of bathrooms, square footage, number of stories, lot size, year built, listing status, listing price, proposed offer price, Zestimate value, Zillow range, Mello-Roos, capitalization rate, fair market rent, taxes, net operating income, property management fees, homeowner associates fees, insurance, and total expenses. Additional property blocks can be viewed by scrolling down the page or selecting the next page.

ISP 104 rank orders the matching properties with the best characteristic as defined by the selected sort field in block 236 presented first and remaining properties in descending order. For example, if investor 102 indicates the properties should be sorted by capitalization rate, ISP 104 will order the resulting list of properties with the highest calculated capitalization rate occupying the first position in the property blocks on webpage 220. Similarly, ISP 104 places the property with the second highest calculated capitalization rate at the second position in the list of property blocks, and so on. The sort operation presents the matching properties in a rank-ordered manner determined by the selected sort field that is relevant or important for investor 102 and simplifies the review and evaluation process by the investor.

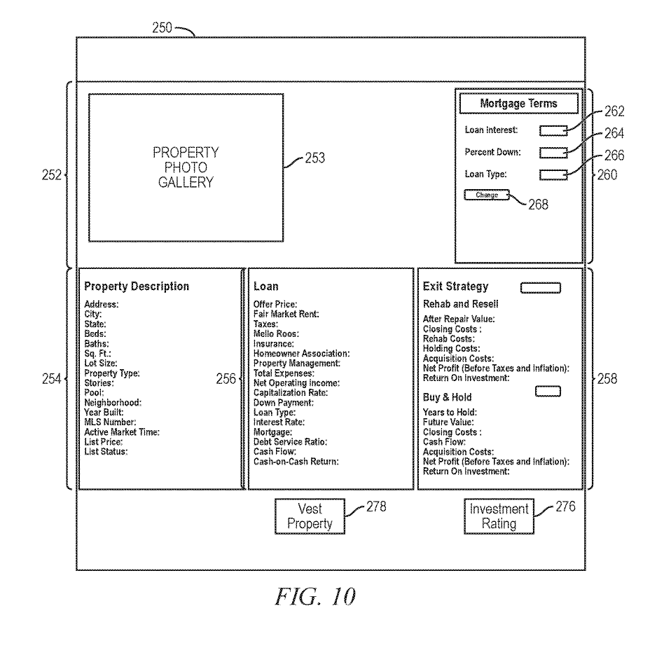

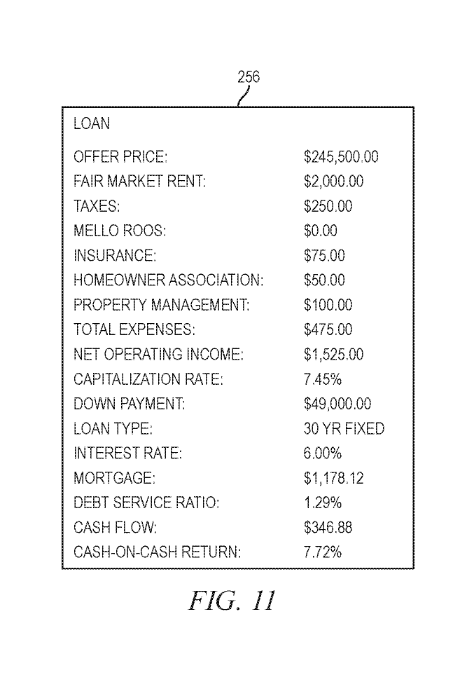

Investor 102 selects one of property blocks 246-248 for further investment analysis by clicking on the property photo or summary property information in the corresponding property block. Assume investor 102 shows interest in property block 246 by clicking on the corresponding photo or summary property information. FIG. 10 shows details for property block 246 on asset webpage 250 with photograph block 252, property description block 254, loan block 256, and exit strategy block 258. Property photo gallery 253 includes one or more thumbnail pictures of property 246. Photo gallery 253 can include photos and videos from Microsoft's Bird's Eye View, Google, and other websites 137. Investor 102 can manually browse the thumbnail photos or select a slideshow to cycle the photos at a predetermined interval, e.g., every ten seconds. Property description block 254 shows address, city, state, number of bedrooms, number of bathrooms, square footage, lot size, property type, number of stories, pool, neighborhood, year built, MLS number, active market time, listing price, and listing status, such as bank-owned or short sale, as collected from MLS 132.

FIG. 11 shows further detail of loan block 256 for property 246 with an investment analysis generated by ISP 104. The investment analysis proposes an offer price of $245,500.00, monthly fair market rental value of $2000, taxes of $250.00, Mello-Roos of $0.00, insurance of $75.00, homeowner association dues of $50.00, and property management fees of $100.00. The total monthly expenses are $475.00 leaving a net operating income of $2000-475.00=$1525. The investment analysis for matching property 246 further determines or proposes a capitalization rate of 7.45%, downpayment of $49,000.00, loan type of 30 year fixed, interest rate of 6.00%, mortgage payment of $1178.12, debt service ratio of 1.29, cash flow of $346.88, and cash-on-cash return of 7.72%, as described in more detail below.

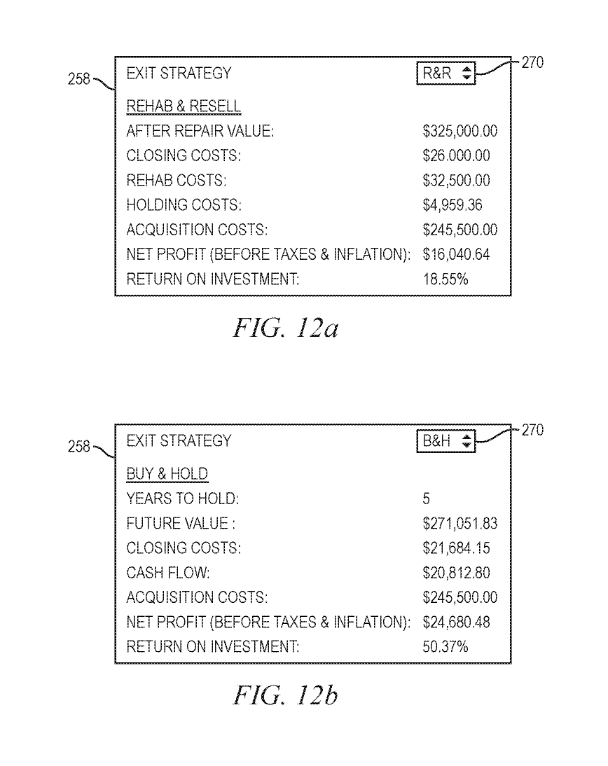

FIGS. 12a-12b show further detail of exit strategy block 258 for property 246 with an investment analysis generated by ISP 104. The exit strategies are based on rehab and sell (R&R) or buy and hold (B&H). In FIG. 12a, the investment analysis for the rehab and resell exit strategy proposes an after repair value of $325,000.00, closing cost of $26,000.00, rehab and improvements of $32,500.00, holding costs of $4959.36, acquisition cost of $245,500.00, net profit before taxes and inflation of $16,040.64, and return on investment of 18.55%. In FIG. 12b, the investment analysis for the buy and hold exit strategy proposes a years to hold period of 5 years, future value of $271,031.83, closing costs at sale of $21,684.15, cash flow over 5 years of $20,812.80, acquisition cost of $245,000.00, net profit before taxes and inflation of $24,680.48, and return on investment of 50.37% for the years to hold period, as described in more detail below.

The investment analysis performed by ISP 104, as described in FIGS. 11 and 12a-12b, with associated sale transaction values and key investment indicators is determined from real estate related information stored in central database 140 as collected from a variety of public and private sources, including the members of commerce system 112 and various websites. Central database 140 also contains real estate related information from investor feedback. Investors 102 can provide information after the sale transaction as to the accuracy and relevance of the real estate information in central database 140. ISP 104 updates central database 140 based on the feedback from the investors who have used the service. The real estate related information in central database 140 in combination with search and selection criteria entered by investor 102, as well as sale transaction value overrides by investor 102, generates the investment analysis.

Central database 140 contains a large number of values or data points for each of the property attributes as compiled from the public and private sources. One property attribute is selling price of similar properties in the area of property 246, i.e., comps, collected from real estate agent 130, MLS 132, home inspection and appraisal service 133, and title service 134. Another property attribute is repair and maintenance costs obtained from repairs and maintenance service 122. Another property attribute is tax records obtained from local government 124 and title service 134. ISP 104 performs a validity check on the data points. For example, ISP 104 confirms the timeliness of the data point according to the timestamp of the record. If a selling price data point is relatively dated, e.g., more than one year old, then the data point can be discarded. Property values can change dramatically over a relatively short period of time. If a repair and maintenance cost is a negative value, then an error is assumed and the data point is discarded. If a data point is substantially different from a similar data point, e.g., tax records for 2010 are 200% greater than tax records 2008 and 2009, then the data point is suspect and discarded. In other cases, invalid or suspect data points are included in the investment analysis calculation but the investment analysis value presented to investor 102 is flagged with an asterisk for confirmation or further investigation of the suspect or invalid data point. The validity checking of the data points in central database 140 increases the accuracy of the investment analysis and provides a measure of confidence for investor 102.

Returning to FIG. 11, ISP 104 accesses central database 140 to gather data points from multiple sources and determine specific sale transaction values used in the investment analysis. ISP 104 determines the proposed or suggested offer price to be made by investor 102 for property 246 based on an estimated value of the property from data points in central database 140 collected from multiple sources. The estimated value is determined from recorded selling prices of similar properties in the area of property 246. For example, the estimated value is market selling price per square foot times the square footage of property 246. The market selling price per square foot can be an average of the data points collected from multiple sources, such as MLS 132, home inspection and appraisal service 133, Zillow Zestimate, Eppraisal.com, CoreLogic, and other websites 137. The average can be a root mean square or weighted average based on historical accuracy of the respective sources. Investor 102 can enter an offer price in loan block 256 based on his or her own determination of the fair market value. The offer price entered by investor 102 overrides the ISP 104 proposed offer price. Investor 102 can also enter a range of offer prices, which will translate into a corresponding range of values for key investment indicators in the investment analysis.

ISP 104 determines the fair market rent value that can be expected by investor 102 for property 246 based on data points from multiple sources in central database 140. The fair market rent value is determined from known rental rates of similar properties in the area of property 246. For example, the fair market rent value is market rental rate for a given number of bedrooms corresponding to the number of bedrooms in property 246. The fair market rent value can be based on rental rate per square foot times the square footage of property 246. The fair market rent value can be an average of the data points collected from MLS 132, Department of Housing and Urban Development's (HUD), Craigslist/Padmapper, Rentometer, Zillow Rent Zestimate, HotPads.com, Move.com, Oodle, and other websites 137. The average can be a root mean square or weighted average based on historical accuracy of the respective sources.

Other factors that influence fair market rent value include property type, year built, lot size, and neighborhood quality indicators, such as crime rate, walkscore, and school boundaries and rating. For example, if the crime rate for the neighborhood is considered to be high relative to other neighborhoods, the fair market rent value could be multiplied by a factor less than 1, e.g., 0.90. Conversely, if the property has been recently built, the fair market rent value could be multiplied by a factor greater than 1, e.g., 1.10. ISP 104 can determine the crime rate from SpotCrime.com, which provides information on various crimes reported in the vicinity of property 246. ISP 104 can determine the walk score or walkability rating from Walkscore.com as an indication of ease of accomplishing errands and other tasks by walking from the property location. Investor 102 can enter a rental value in loan block 256 based on his or her own determination of the fair market rent value. The fair market rent value entered by investor 102 overrides the ISP 104 proposed fair market rent value. Investor 102 can also enter a range of fair market rent values, which will translate into a corresponding range of values for key investment indicators in the investment analysis.

In addition to the fair market rent value, ISP 104 can determine a gross rent multiplier as a ratio of offer price to annual fair market rent, i.e., offer price/annual fair market rent ($245,500/(12×$2000)=10.23. In another example, if investor knew that he or she wanted to achieve a gross rent multiplier of 9 and was considering an offer price of $245,500, then the annual fair market rent would be $245,500/9=$27,277.78. If investor knew that he or she wanted to achieve a gross rent multiplier of 9 and was expecting annual fair market rent of $24,000, then the offer price would be $24,000*9=$216,000.00.

ISP 104 determines taxes for property 246 based on data points from one or more sources in central database 140. For example, the taxes are obtained from local government 124, professional management services 126, and bank 128. Mello-Roos refers to a California specific tax provision that assesses homeowners in some California communities for repayment of bonds used to fund the infrastructure within their community. Other states may have similar tax assessments.

ISP 104 determines insurance, homeowner association fees, and management values for property 246 based on data points from one or more sources in central database 140. For example, the insurance, homeowner association fees, and management values are obtained from insurance 125, professional management services 126, and real estate agent 130.

ISP 104 determines total expenses as the sum of taxes, Mello-Roos, insurance, homeowners association fees, and property management fees, usually on a monthly basis.

ISP 104 determines the net operating income as the fair market rent value less the total expenses, usually on a monthly basis. The net operating income is a key investment indicator for property 246.

ISP 104 determines the capitalization rate as the ratio of annual net operating income to offer price, i.e., capitalization rate=annual net operating income/offer price. Investor 102 can enter the asking price for property 246 from MLS 132 as the offer price to obtain a conservative capitalization rate. The capitalization rate is a key investment indicator for property 246.

ISP 104 determines the downpayment as a percentage of the offer price, typically 10-20% of the offer price. Investor 102 can enter a downpayment in loan block 256 based on his or her own determination of the capital investment. The downpayment entered by investor 102 overrides the ISP 104 proposed downpayment.

ISP 104 determines the loan type from a default loan type (30 year fixed rate mortgage) or retrieves a previous loan type selected by investor 102 on other investment analysis sessions. For example, investor 102 may prefer 30 year fixed rate mortgages. Investor 102 can enter a different loan type, e.g., 30 year variable rate, 15 year fixed rate, 15 year variable rate, 15 year interest only, and the like. The loan type entered by investor 102 overrides the ISP 104 proposed loan type.

ISP 104 determines the interest rate from one or more sources in central database 140. The interest rate can be obtained from bank 128 or real estate agent 130. ISP 104 can search a number of lenders on behalf of investor 102 in order to find the best financing terms in light of the investor's credit rating, income, debt to income ratio, and other financial conditions. ISP 104 can select the best interest rate qualified for investor 102 and obtain pre-approval for the investor. Investor 102 can enter an interest rate in loan block 256 based on his or her own determination of available market loan rates. The interest rate entered by investor 102 overrides the ISP 104 proposed interest rate.

ISP 104 determines the mortgage based on offer price, downpayment, loan type, and interest rate. Asset webpage 250 allows investor 102 to change the mortgage terms in block 260 of FIG. 10. Investor 102 can change interest rate in block 262, percent downpayment in block 264, and loan type in block 266. Investor clicks on change block 268 to update the mortgage terms.

ISP 104 determines the debt service ratio as the ratio of mortgage to net operating income, i.e., net operating income/mortgage. A debt service ratio greater than 1 generally indicates a positive cash flow, and a debt service ratio less than 1 generally indicates a negative cash flow. ISP 104 determines cash flow as net operating income less mortgage, typically on a monthly basis. ISP 104 determines cash-on-cash return as the ratio of annual cash flow to cash to close, i.e., annual cash flow/cash to close. The cash to close value includes downpayment, closing costs, and rehab and improvements. Closing costs and rehab and improvement can be obtained from one or more sources in central database 140, e.g., title service 134, real estate agent 130, and repair and maintenance service 122. Closing costs for investor 102 (buyer) are typically 2% of the offer price. The debt service ratio, cash flow, and cash-on-cash return are key investment indicators.

Returning to FIGS. 12a-12b, investor 102 selects an exit strategy in block 270 with a pull down menu. The possible exit strategies include rehab and resell or buy and hold, and Section 1031 exchange, which defers capital gains taxes from the sale of certain qualifying investment property.

In the rehab and resell exit strategy of FIG. 12a, investor 102 makes certain improvements to property 246 intended to increase its market value in the short term, e.g., three months, for the purpose of reselling the property as soon as practical. In the investment analysis of property 246 under the rehab and resell exit strategy, ISP 104 accesses central database 140 to gather data points from multiple sources and determine specific sale transaction values used in the investment analysis.

ISP 104 determines a proposed or suggested after repair value, i.e., the estimated resell value of property in a short time after the purchase given certain improvements. ISP 104 obtains repair and maintenance advice and costs from repair and maintenance service 122, property management service 126, and real estate agent 130. The after repair value is determined from recorded selling prices of similar properties with the given improvements in the area of property 246. For example, the after repair value is market selling price per square foot of a property with the improvements times the square footage of property 246. The after repair value can be an average of the data points collected from multiple sources, such as MLS 132, home inspection and appraisal service 133, Zillow Zestimate, Eppraisal.com, CoreLogic, and other websites 137. The average can be a root mean square or weighted average based on historical accuracy of the respective sources. Alternatively, ISP 104 can assign an after repair value as the offer price times a default improvement factor, e.g., 10/7 or 1.42. Investor 102 or ISP 104 can engage an appraiser to do a comparative market analysis of property 246 based on the proposed improvements. Investor 102 can enter an after repair value in exit strategy block 258 based on his or her own determination of the after repair market value. The after repair value entered by investor 102 overrides the ISP 104 proposed after repair price. Investor 102 can also enter a range of after repair values, which will translate into a corresponding range of values for key investment indicators in the investment analysis.

ISP 104 determines closing costs for the resale of property 246 with improvements. The closing costs are based on data points from multiple sources in central database 140, such as real estate agent 130 and title service 134. In one embodiment, closing costs are estimated as 8% of after repair value, assuming 6% real estate agent fees and 2% other closing costs for investor 102 (seller). Investor 102 can enter closing costs in exit strategy block 258 based on his or her own determination of the closing costs, e.g., factoring in reduced real estate agent fees. The closing costs entered by investor 102 override the ISP 104 proposed closing costs.

ISP 104 determines rehab and improvement costs to increase property value and place property 246 in condition for resale in view of after repair value. The rehab and improvement costs are based on data points from multiple sources in central database 140, such as repair and maintenance service 122, real estate agent 130, and home inspection and appraisal service 133. In one embodiment, rehab and improvement costs are estimated as 10% of the offer price or after repair value. A well-reasoned after repair value and rehab and improvement costs are important factors to the rehab and resell exit strategy. Investor 102 can enter rehab and improvements costs in exit strategy block 258 based on his or her own determination of the rehab and improvement costs. The rehab and improvement costs entered by investor 102 override the ISP 104 proposed rehab and improvement costs.

ISP 104 determines holding costs related to routine operating cost of ownership of property 246 between the time of purchase and resale. The holding costs are based on data points from multiple sources in central database 140, such as utilities 120, repair and maintenance service 122, professional management services 126, and real estate agent 130. In one embodiment, holding costs are estimated as three times the sum of total expenses and mortgage, assuming three months from purchase to resale. Investor 102 can enter holding costs in exit strategy block 258 based on his or her own determination of the holding costs. The holding costs entered by investor 102 override the ISP 104 proposed holding costs.

ISP 104 determines acquisition costs related to capital outlay and debt incurred required to acquire property 246. The acquisition costs are based on data points from multiple sources in central database 140, such as real estate agent 130 and title service 134. In one embodiment, acquisition cost is the offer price. Investor 102 can enter acquisition costs in exit strategy block 258 based on his or her own determination of the acquisition costs. The acquisition costs entered by investor 102 override the ISP 104 proposed acquisition costs.

ISP 104 determines net profit before taxes and inflation from the rehab and resell exit strategy for property 246. The net profit is the after repair value less the sum of closing costs, rehab and improvement costs, holding costs, and acquisition cost. ISP 104 determines return on investment from the rehab and resell exit strategy for property 246. The return on investment is the ratio of the net profit to the sum of holding costs, rehab and improvement costs, and downpayment. The return on investment is a key investment indicator.

In the buy and hold exit strategy of FIG. 12b, investor 102 acquires property 246 with the intent of retaining the property for an extended period of time. In the investment analysis of property 246 under the buy and hold exit strategy, ISP 104 accesses central database 140 to gather data points from multiple sources and determine specific sale transaction values used in the investment analysis. ISP 104 determines a proposed or suggested years to hold. ISP 104 assumes a default years to hold value of 5 years. Investor 102 can enter a years to hold value in exit strategy block 258 based on his or her own plans. The years to hold value entered by investor 102 overrides the ISP 104 proposed years to hold value.

ISP 104 determines a future value of property 246 after the conclusion of the years to hold value. The future value is based on data points from multiple sources in central database 140, such as real estate agent 130, MLS 132, home inspection and appraisal service 133, Zillow Zestimate, Eppraisal.com, CoreLogic, and other websites 137, to determine average annual increases in value for properties similar to property 246. In one embodiment, the future value is estimated as the present value or offer price times the average increase in value for similar properties over the years to hold value. Alternatively, the future value is a present value times a default annual increase, e.g., 2-4%, over the years to hold value. In other cases, the future value is the present value times (1+i)^{t}, where i is the interest rate per compound period, t is the number of compounding periods over the years to hold. Investor 102 can enter a future value in exit strategy block 258 based on his or her own determination of the future value. The future value entered by investor 102 overrides the ISP 104 proposed future value.

ISP 104 determines closing costs for the resale of property 246 after the years to hold period. The closing costs are based on data points from multiple sources in central database 140, such as real estate agent 130 and title service 134. In one embodiment, closing costs are estimated as 8% of the future value, assuming 6% real estate agent fees and 2% other closing costs for investor 102 (seller). Investor 102 can enter closing costs in exit strategy block 258 based on his or her own determination of the closing costs, e.g., factoring in reduced real estate agent fees. The closing costs entered by investor 102 override the ISP 104 proposed closing costs.

ISP 104 determines cash flow over the years to hold period as monthly cash flow times the number of months in the years to hold period.

ISP 104 determines acquisition costs related to capital outlay and debt incurred required to acquire property 246. The acquisition costs are based on data points from multiple sources in central database 140, such as real estate agent 130 and title service 134. In one embodiment, acquisition cost is the offer price. Investor 102 can enter acquisition costs in exit strategy block 258 based on his or her own determination of the acquisition costs. The acquisition costs entered by investor 102 override the ISP 104 proposed acquisition costs.

ISP 104 determines net profit before taxes and inflation from the buy and hold exit strategy for property 246. The net profit is the sum of the future value and cash flow less the sum of closing costs and acquisition cost, i.e., (future value+cash flow)−(closing costs+acquisition costs). ISP 104 determines return on investment from the buy and hold exit strategy for property 246. The return on investment is the ratio of the net profit to downpayment, e.g., net profit/downpayment. The return on investment is a key investment indicator.

After reviewing the investment analysis for property 246, investor 102 can request investment analysis for properties 247 and 248 by clicking on the respective property block in FIG. 8. Investor 102 can conduct additional searches through ISP 104 with selection criteria including the key investment indicators capitalization rate, net operating income, debt service ratio, cash flow, cash-on-cash return, and return on investment. That is, investor 102 can request properties that would deliver specific ranges or maximum capitalization rate, specific ranges or maximum net operating income, specific ranges or maximum debt service ratio, specific ranges or maximum cash flow, specific ranges or maximum cash flow, specific ranges or maximum cash-on-cash return, or specific ranges or maximum return on investment. The matching properties can be sorted by the key investment indicators.

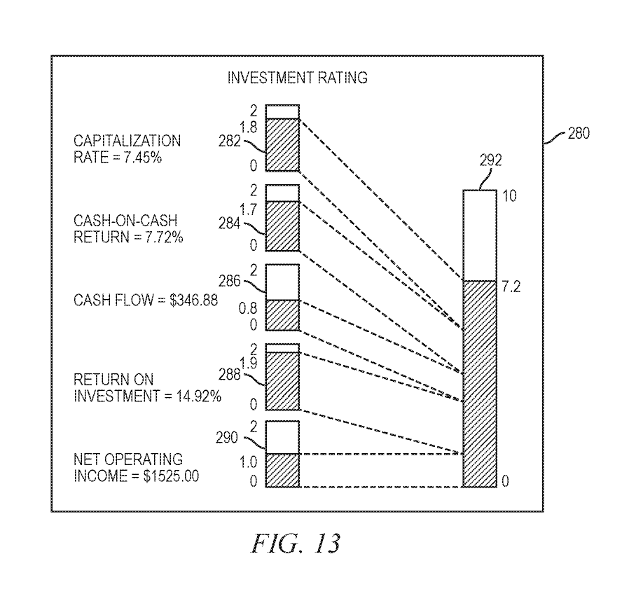

Asset webpage 250 further includes an investment rating (IR) button 276 to launch IR webpage 280, as shown in FIG. 13. IR webpage 280 takes into account multiple key investment indicators to determine the investment rating. The investment rating provides an indication of the overall quality of the investment based on multiple key investment indicators, as well as equity. In the present example, the key investment indicators are capitalization rate, cash-on-cash return, cash flow, return on investment, and net operating income taken from FIGS. 11 and 12a. Each key investment indicator is assigned a comparative value based on historical ranges of known similar key investment indicators. In this case, with five key investment indicators, the scale is 0 to 2. A capitalization rate of 7.45% from FIG. 11 is determined to have a comparative value of 1.8 on the scale of 0 to 2 in block 282 relative to historical ranges of known capitalization rate values for similar properties. A cash-on-cash return of 7.72% from FIG. 11 is determined to have a comparative value of 1.7 on the scale of 0 to 2 in block 284 relative to historical ranges of known cash-on-cash return values for similar properties. A cash flow of $346.88 from FIG. 11 is determined to have a comparative value of 0.8 on the scale of 0 to 2 in block 286 relative to historical ranges of known cash flow values for similar properties. A return on investment of 18.55% from FIG. 12a is determined to have a comparative value of 1.9 on the scale of 0 to 2 in block 288 relative to historical ranges of known return on investment values for similar properties. A net operating income of $1525.00 from FIG. 11 is determined to have a comparative value of 1.0 on the scale of 0 to 2 in block 290 relative to historical ranges of known net operating income value values for similar properties. The comparative values of the key investment indicators are summed together to determine the investment rating, e.g., 1.8+1.7+0.8+1.9+1.0=7.2. The investment rating 292 is shown graphically as 7.2 on a scale of 0 to 10. The key investment indicators can be weighted in terms of accuracy or relevance to investor 102.

In another embodiment, the investment rating is based on the key investment indicators, as well as other socio-economic factors that are not otherwise quantified as the key investment indicators. The socio-economic factors include affordability, year built, property type, schools, weather patterns, local job market, population growth, tax bracket, property value trends, foreclosure rates, inflation, lost opportunity cost, and exit strategy. The socio-economic factors can be weighted in terms of accuracy or importance to investor 102.

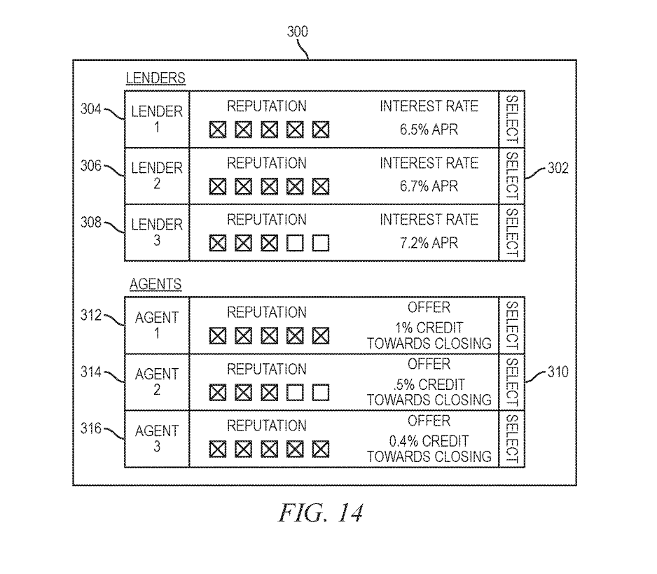

Asset webpage 250 further includes a vest property button 278 to launch vest property webpage 300, as shown in FIG. 14. Once investor 102 makes a decision to initiate a sale transaction to acquire property 246, vest property webpage 300 provides the investor a list of service providers to engage and conduct the sale transaction. The service providers include lenders, brokers, appraisers, title companies, banks, escrow companies, housing inspectors, and county recorders.

Vest property webpage 300 shows a lender selection block 302 with lenders 304, 306, and 308. After investor 102 makes the decision to initiate a sale transaction, ISP 104 can release the details of the necessary financing to a number of lenders in a bidding process. ISP 104 may already have standing offers from numerous lenders for a selection of loans. Lenders 304-308 are selected by ISP 104 as having the best terms based on the financial position of investor 102.

Lender selection block 302 shows reputation ratings and interest rates for lenders 304-308. The reputation data can be collected from Yelp and other websites 137. Investor 102 can decide which lender suits his or her needs and clicks the corresponding select button. ISP 104 transfers investor 102 to the selected lender's webpage to verify income, assets, credit, and down payment information. Desktop underwriting loan approval can also be obtained. The desktop underwriting is an automated underwriting process that can reduce the time required to underwrite a mortgage loan application.

Vest property webpage 300 shows a real estate agent selection block 310 with agents 312, 314, and 316. After investor 102 makes the decision to initiate a sale transaction, ISP 104 can release the details of the proposed sale transaction for property 246 to a number of agents in a bidding process. Agents 312-316 are selected by ISP 104 as having the best terms or professional experience for property 246.

Real estate agent selection block 310 shows reputation ratings and interest rates for agents 312-316. The data for determining the reputation ratings can be collected from Yelp and other websites 137. Investor 102 can decide which agent suits his or her needs and clicks the corresponding select button. ISP 104 transfers investor 102 to the selected agent's webpage with the sale transaction proposal. The selected agent is authorized to make an offer for property 246 on behalf of investor 102. The offer can be accompanied by proof of funds or desktop underwriting approval.

Vest property webpage 300 can include additional service providers that handle each step in the sale transaction, purchase process, e.g., home inspection, appraisal, title services, insurance agents, escrow agents, home warranty, credit repair, brokerage, financial planners, wealth managers, life insurance, building contractors, law firms and attorneys, interior designers, tax professionals, pest control, and cleaning services.

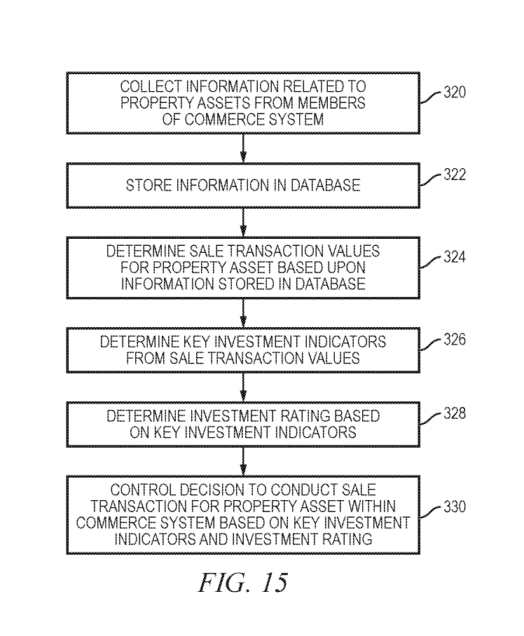

FIG. 15 illustrates a process for controlling a commerce system by utilizing the key investment indicators and investment rating to control a decision to conduct a sale transaction for the property asset within the commerce system. In step 320, information related to property assets is collected from the members of the commerce system. The members of the commerce system include an owner, renter, utilities, repair and maintenance service, local government, insurance, professional management service, lending institution, real estate agent, multiple listing service, home inspection and appraisal service, title service, legal representation, websites, investor, and investment service provider, In step 322, the information is stored in a central database. In step 324, a plurality of sale transaction values is determined for the property asset based upon the information stored in the central database. The sale transaction values include offer price, fair market rent, taxes, Mello-Roos, insurance, homeowner association fees, property management fees, total expenses, downpayment, loan type, interest rate, and mortgage payment. In another embodiment, the sale transaction values include after repair value, closing costs, rehab and improvement costs, holding costs, acquisition costs, and net profit. In another embodiment, the sale transaction values include years to hold, future value, closing costs, acquisition costs, and net profit. In step 326, a plurality of key investment indicators is determined from the sale transaction values. The key investment indicators include net operating income, capitalization rate, debt service ratio, cash flow, cash-on-cash return, and return on investment. In step 328, an investment rating is determined based on the key investment indicators. In step 330, a decision to conduct a sale transaction for the property asset within the commerce system is controlled based on the key investment indicators and investment rating.

In summary, the investor and investment service provider in part control a decision to conduct a sale transaction for the property asset within the commerce system based on the key investment indicators and investment rating. The investment service provider collects information related to property assets from the members of the commerce system. The information is stored in a database. The investment service provider determines a plurality of sale transaction values for the property asset based upon the information stored in the database. The investment service provider further determines a plurality of key investment indicators from the sale transaction values and determines an investment rating based on the key investment indicators. The decision to conduct a sale transaction engages the members of the commerce system to take the appropriate steps to complete the transaction.

The investment service provider offers the investor a set of tools to perform investment due diligence on potential investment properties. The investment service provider gives the investor the ability to search multiple investment properties using property attributes or one or more key investment indicators and provide reliable and comprehensive risk assessment and investment analysis of each investment property. The investment service provider rank orders each investment property based upon the selected sort field. The investment service provider saves the investor considerable time and money by providing access to a comprehensive, reliable, and objective investment model or comparative investment service. The key investment indicators and rankings of the properties can be stored and utilized by the investor to identify one or more properties that represent a sound investment based on their particular investment strategy.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of using a property investment analysis tool for a real property asset, comprising:
providing a plurality of real property assets;
collecting information related to the real property assets from a plurality of property data sources over a communication network, wherein the information includes a plurality of transaction values for each of the real property assets;
storing the real property assets and the information in a database;
searching the real property assets based on search criteria using the property investment analysis tool by calculating key investment indicators including net operating income, capitalization rate, debt service ratio, cash flow, cash-on-cash return, and return on investment from the information in the database;
identifying the real property assets in the database matching the search criteria for the key investment indicators and rank ordering the identified real property assets by a selected search criteria; and
selecting one of the identified real property assets and displaying the key investment indicators and an investment rating of the key investment indicators against established ranges for one of the identified real property assets.

2. The method of claim 1, wherein the transaction values include offer price, fair market rent, taxes, Mello-Roos, insurance, homeowner association fees, property management fees, total expenses, downpayment, loan type, interest rate, and mortgage payment.

3. The method of claim 1, wherein the transaction values include after repair value, closing costs, rehab and improvement costs, holding costs, acquisition costs, and net profit.

4. The method of claim 1, further including conducting a real property transfer for selecting one of the identified real property assets.

5. The method of claim 4, further including formulating an exit strategy for selecting one of the identified real property assets from the key investment indicators.

6. The method of claim 1, wherein the property data sources are selected from the group consisting of an owner, renter, utilities, repair and maintenance service, local government, insurance, professional management service, lending institution, real estate agent, multiple listing service, home inspection and appraisal service, title service, legal representation, websites, investor, and investment service provider.

7. A method of using a property investment analysis tool for a real property asset, comprising:
providing a plurality of real property assets;
collecting information related to the real property assets from a plurality of property data sources over a communication network, wherein the information includes a plurality of transaction values for each of the real property assets;
storing the real property assets and the information in a database;
searching the real property assets based on search criteria using the property investment analysis tool by calculating key investment indicators from the information in the database;
identifying the real property assets in the database matching the search criteria for the key investment indicators; and
selecting one of the identified real property assets and displaying the key investment indicators for one of the identified real property assets.

8. The method of claim 7, further including rank ordering the identified real property assets.

9. The method of claim 7, further including determining an investment rating of the key investment indicators against established ranges for one of the identified real property assets.

10. The method of claim 7, wherein the transaction values include offer price, fair market rent, taxes, Mello-Roos, insurance, homeowner association fees, property management fees, total expenses, downpayment, loan type, interest rate, and mortgage payment.

11. The method of claim 7, wherein the transaction values include after repair value, closing costs, rehab and improvement costs, holding costs, acquisition costs, and net profit.

12. The method of claim 7, wherein the key investment indicators are selected from the group consisting of a net operating income, capitalization rate, debt service ratio, cash flow, cash-on-cash return, and return on investment.

13. The method of claim 7, wherein the property data sources are selected from the group consisting of an owner, renter, utilities, repair and maintenance service, local government, insurance, professional management service, lending institution, real estate agent, multiple listing service, home inspection and appraisal service, title service, legal representation, websites, investor, and investment service provider.

14. A computer program product usable with a programmable computer processor having a computer readable program code embodied in a computer usable medium for a property investment analysis tool for a real property asset, comprising:
providing a plurality of real property assets;
collecting information related to the real property assets from a plurality of property data sources over a communication network, wherein the information includes a plurality of transaction values for each of the real property assets;
storing the real property assets and the information in a database;
searching the real property assets based on search criteria using the property investment analysis tool by calculating key investment indicators from the information in the database;
identifying the real property assets in the database matching the search criteria for the key investment indicators; and
selecting one of the identified real property assets and displaying the key investment indicators for one of the identified real property assets.

15. The computer program product of claim 14, further including rank ordering the identified real property assets.

16. The computer program product of claim 14, further including determining an investment rating of the key investment indicators against established ranges for one of the identified real property assets.

17. The computer program product of claim 14, wherein the transaction values include offer price, fair market rent, taxes, Mello-Roos, insurance, homeowner association fees, property management fees, total expenses, downpayment, loan type, interest rate, and mortgage payment.

18. The computer program product of claim 14, wherein the transaction values include after repair value, closing costs, rehab and improvement costs, holding costs, acquisition costs, and net profit.

19. The computer program product of claim 14, wherein the key investment indicators are selected from the group consisting of a net operating income, capitalization rate, debt service ratio, cash flow, cash-on-cash return, and return on investment.

20. The computer program product of claim 14, wherein the property data sources are selected from the group consisting of an owner, renter, utilities, repair and maintenance service, local government, insurance, professional management service, lending institution, real estate agent, multiple listing service, home inspection and appraisal service, title service, legal representation, websites, investor, and investment service provider.
